(19) United States
(12) Patent Application Publication
(10) Pub. No.: US 2006/0188864 A1
(43) Pub. Date: Aug. 24, 2006

(54) Automated transfer of data from PC clients

(76) Inventor: Pankaj Shah, Palo Alto, CA (US)

Correspondence Address: PILLSBURY WINTHROP SHAW PITTMAN LLP, P.O. BOX 10500, MCLEAN, VA, 22102, US

(21) Appl. No.: 11/345,627

(22) Filed: Jan. 31, 2006

Related U.S. Application Data
(60) Provisional application No. 60/648,959, filed on Jan. 31, 2005.
(60) Provisional application No. 60/648,731, filed on Jan. 31, 2005.
(60) Provisional application No. 60/648,733, filed on Jan. 31, 2005.

(51) Int. Cl. G09B 3/00

(52) U.S. Cl. 434/350; 434/351; 434/362

(57) ABSTRACT

Embodiments of the invention provide systems and methods for transferring a data object such as a data file from a PC client to a wireless device regardless of the format of the file and with minimum user intervention. A system is disclosed wherein the file is transferred from a PC client through the Internet to a server and ultimately to a device, which can be a wireless device, a peer-to-peer device, or any suitable device capable of receiving an over the air transmission.

### RELATED APPLICATIONS

The present application claims benefit of priority from provisional patent application No. 60/648,959 entitled “Short Query-based System and Method for Content Searching,” filed Jan. 31, 2005, and from provisional patent application No. 60/648,731 entitled “Prioritization of Search Responses System and Method,” filed Jan. 31, 2005, and from provisional patent application No. 60/648,733 entitled “Automated Transfer of Data from PC Clients,” filed Jan. 31, 2005, which provisional applications are incorporated herein by reference and for all purposes.

### BACKGROUND OF THE INVENTION

Most file transfer systems for transferring a file from a computer to a wireless device require that the wireless device be coupled to the computer. For example, currently known methods require use of a serial port or a USB port to couple the wireless device to the computer. Once the wireless device is coupled to the computer, then the user must follow several steps in order to effectively transfer the file from the computer to the wireless device. For example, the user must typically launch the transfer program, then convert the file to the proper format if necessary and finally transfer the file. Furthermore, it is currently not possible to parse and convert web pages, outlook events or pictures from a PC or computer to a wireless device.

Thus, a system and method are needed for efficiently transferring a file from a computer or a PC client to a wireless device without requiring that the wireless device be physically coupled to the PC client and with minimum input from the user.

### SUMMARY OF THE INVENTION

A system and method are disclosed that include the ability to transfer a data object such as a data file from a PC client to a wireless device regardless of the format of the file with minimum user intervention. A system is shown wherein the file is transferred from a PC client through the Internet to a server and ultimately to a device, which can be a wireless device, a peer-to-peer device, or any suitable device capable of receiving an over the air transmission.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIG. 1 is a flowchart of the process of transporting a file from a PC client to a wireless device in accordance with the teaching of the present invention;

FIG. 2 is a flowchart of the process of transforming a file into a new format that is compatible with the wireless device receiving the file in accordance with the teaching of the present invention; and

FIG. 3 is a system of the present invention for transporting a file from a PC client to a wireless device over the internet.

### DETAILED DESCRIPTION OF THE INVENTION

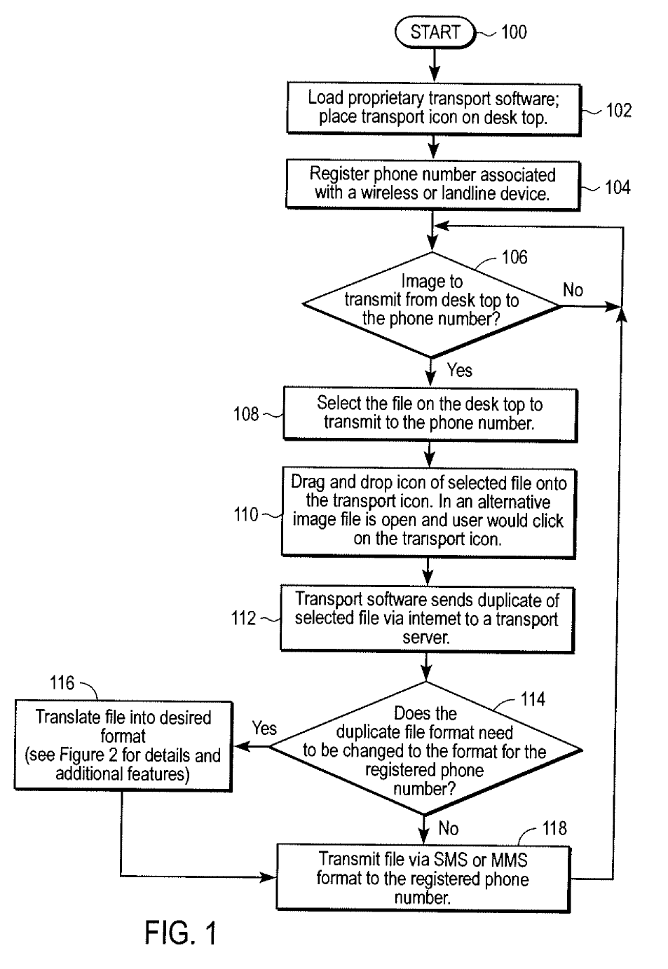

Referring to FIG. 1, the process of transporting a file from a PC client to a wireless device begins at step 100. The term “wireless device” as used herein can refer to a variety of devices capable of receiving information or data over the air. For example, wireless devices can include, but are not limited to, the following: a cell phone, a laptop or a desktop with wireless capabilities, a tablet PC, a GPRS radio device, a handheld PC, or a Blackberry. The file may be any data object adapted to be stored in a file system on the PC client and can include specific types of files that can be identified with applications such as data bases, calendars and other systems. At step 102, appropriate software is loaded into the memory of the PC client and a transport icon is presented to the user through the Graphical User Interface (GUI) or monitor. It will apparent to those skilled in the art that loading the software and presenting the transport icon to the user by placing the icon on the desktop of the PC client is typically a one-time procedure and does not need to be repeated every time a file is transferred. The software typically includes many features that allow the user to fully utilize the benefits of the disclosed invention. For example, the software can handle future delivery scheduling, managing registration of a wireless device with a server using a PC Client, updating the user regarding delivery of messages to the destination and notifying the user of any errors related to the transmission. With respect to future delivery, software is capable of handling scheduling requests for delivery of a file at a future date; future delivery can also be handled by the server as discussed in detail below. Such future deliveries can include files associated with electronic birthday cards, airline schedules or reminders of upcoming events. Once the software is loaded, as part of the initial installation process, various icons are generated. For example, an icon can be included as part of a program menu, a tool bar, or a desk-top icon on the PC client. One type of icon is associated with the transportation process and another type of icon is specifically for the registration process so that additional devices or new devices can be registered at a later time.

At step 104, during the installation process the user can register the destination address of the wireless device to which the files will be transported. The destination address may be, for example, a number for a cell phone or an IP address (either wired or wireless), or both number and IP address, or any other indicia which uniquely identify the destination. Furthermore, the user can register a destination address by clicking on an icon specific to initiating the registration process. For example, the wireless device may be a computer that is connected to the internet via a wireless connection using a wireless modem card or the wireless connection can be through an 802.11 wireless connection, which would require registration of an IP address instead of or in addition to registration of a phone number. During the registration process, the user typically provides information that includes the phone number or destination address, the type device, the model number, and/or the manufacturer. The software can also include a look-up table such that a user can enter basic information about the device at the destination and be presented with a list of choices by the software, which would refer to a look-up table for such information. For example, the user can provide the name of the manufacturer and the software can provide a list of devices for that manufacturer that the user can select from to designate the type of device at the origin. This information can be used to identify device capabilities. The information provided during the registration process is referred to herein as the “registered information” for simplicity. The process of registration with the server is achieved using the PC client connected to the server through a secure Internet connection, as discussed in detail below. During the registration process, either at the initial installation of the software or at a later date, the registered information is stored at the server. If during the registration process, the PC client is not coupled to the Internet and, hence, not capable of communicating with the server, the registration process is completed by the software resident at the PC client and queued for later delivery to the server when the PC client is connected to the Internet. In certain embodiments, the registered information may be stored by the software and communicated to the server each time information is delivered to the server.

Once the software is loaded and the phone number or the IP address of the wireless device is registered, then at step 106 it is determined if the user desires to transport a duplicate copy of a file resident on the PC client to the wireless device. If so, then at step 108 the user selects the file resident on the PC client to be transported to the wireless device associated with the registered information. At step 110, the user drags and drops the icon associated with the file to be transported onto the transport icon. In certain embodiments, the user could be viewing a file, such as a web page. While viewing the file, the user can chose to transport that file from the PC client to the wireless device by clicking on a transport icon that is available in the tool bar. In certain embodiments, the user can drag and drop an Outlook Calendar event onto the transport icon. The software interprets this action and pre-populates a pop-up box and lets the user set an alert and sends the event to the wireless device associated with the registered information. At step 112, the transport software resident on the PC client automatically generates a copy of the file and sends that copied file to the server to be delivered to the wireless device associated with the registered information. As indicated above, during the registration process, the sender registers the destination address or a phone number and this information can resides on an applet associated with the software resident on the PC client as well as on the server. The applet will send the content or the message along with the destination address or phone number that is matched to the server. The server in turn sends the content to the wireless device associated with the registered information.

At step 114 the server determines, based on the wireless device associated with the registered information, if the format of the file needs to be changed in order for the wireless device to be able to receive and read the file being transported. In certain embodiments, the server can deliver the message based on information provided during the registration process. In the event the format is not proper, then the server may receive an error message from the wireless device indicating that there was an error in delivery due to the format or some other attribute of the message. The server may then resend the message in the most popular format or the most commonly used format and if an error message is received again, then the server will alert the user at the PC client that there was an error and the message could not be delivered to the wireless device. In certain embodiments, the error message received from the wireless device at the destination can include information about the device and the server can refer to a look-up table in order to determine the proper format and, thus, automatically update the registered information or store an alternative format for that specific registered information and query the user at the PC client to determine if the registered information needs to be updated. Accordingly, the server may be capable of automatically querying the wireless device at the destination in order to determine the proper format. If the server determines that the file needs to be translated or re-formatted, then at step 116 the server translates the file into the desired format. Then at step 118, the file is transmitted from the server to the wireless device using SMS, MMS, WAP or any suitable protocol. If at step 114 it is determined that the file format does not need to be changed, then the process proceeds to step 118 where the file is delivered to the wireless device. Additionally, as indicated above, the server is capable of handling future deliveries and any file scheduled to be delivered is delivered by the server as necessary.

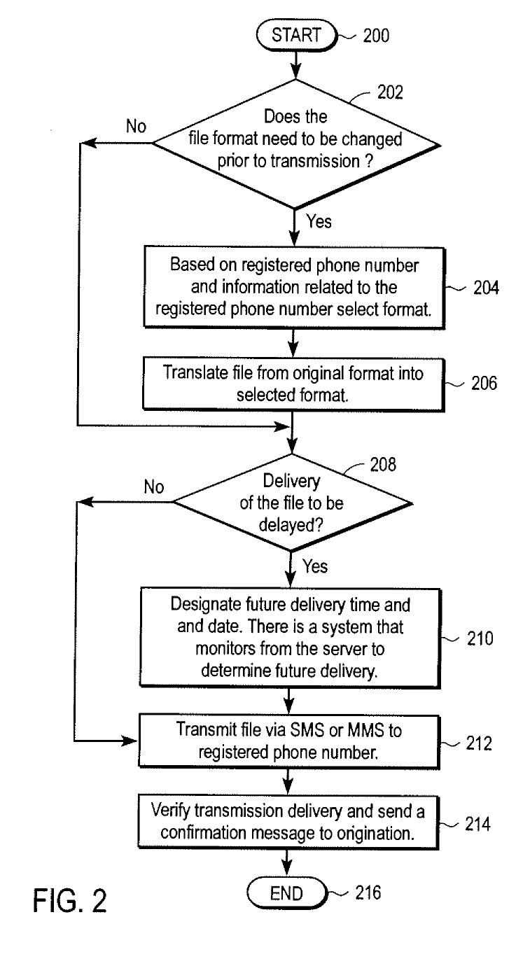

Referring now to FIG. 2, the process of transporting a file begins at step 200. At step 202 it is determined if the file format needs to changed. If not, then the process proceeds to step 208. Otherwise, at step 204, the desired file format is determined based on the wireless device associated with the registered information. At step 206, the server transforms the file into the desired format to produce a transformed or re-formatted file ready for delivery to the wireless device. At step 208, the server determines if this transformed file is scheduled for future delivery. If not, then at step 212 the re-formatted file is immediately delivered via SMS or MMS to the wireless device associated with the registered information. Otherwise the process proceeds to step 210 where the future date and time of delivery is set and the transformed or re-formatted file is stored until the future delivery date.

In certain embodiments, the future date and time of delivery may be established before reformatting the file and the file is stored until that future time in its original format. Once the file is ready to be delivered then the file is re-formatted to the desired format. Thus, the scope of the present invention is not limited by the order in which the delivery scheduling and the file re-formatting occur.

At step 214, the wireless device acknowledges receipt of the file or the reformatted file, depending on the file delivered, to the server and the server can then send a delivery confirmation to the PC client to end the process at step 216.

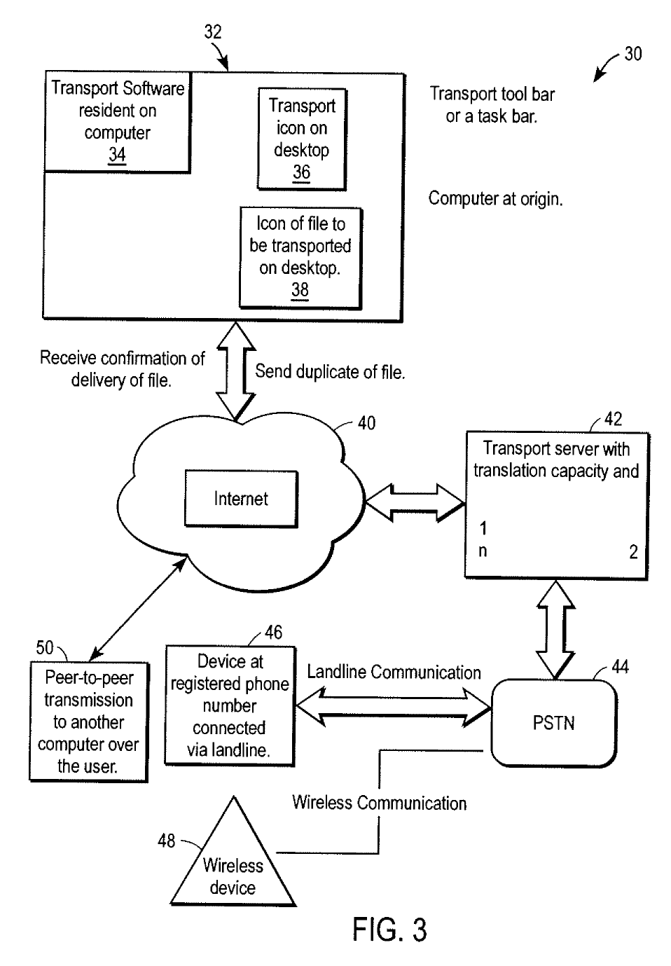

Referring now to FIG. 3, the system 30 in accordance with the present invention includes a PC client or computer 32. The PC client 32 includes a transport software 34 resident therein, a transport icon 36, and at least one file 38 to be transported. The transport icon 36 can be an icon on either the desktop or as part of a toolbar in a typical window-based environment. It will be apparent to those skilled in the art that the scope of the present invention is not limited by the type of operating system. In one embodiment the operating system is a windows based operating system. In another embodiment, the operating system is a Mac OS, or any other suitable operating system such as Linux, Lindows, Solaris, or others.

Once the user selects the file associated with the file icon 38 to be transported and either drags-and-drops the file icon 38 on the transport icon 36 or from within the file clicks on the relevant icon in the tool bar, then the software 34 transports a copy of the file through the Internet 40 to a server 42. The server 42 includes various features as well as the ability to communicate with the software 34 in order to determine the destination of the file, which will be based on information provided by the user during the registration process as discussed above. The server 42 transforms or reformats the file as necessary based on information provided about the wireless device associated with the registered information. The server 42 then delivers the file, which may have been reformatted, through the Public Switched Telephone Network (PSTN) to a device 46 or a wireless device 48.

In certain embodiments, the server 42 can deliver the file through the Internet 40 to a device 50, which can be a peer-to-peer transmission. Once the file is delivered to the desired destination and delivery is confirmed, the server 42 can then send a confirmation message to the PC client 32 through the Internet 40.

Having fully described various embodiment and various alternatives, those skilled in the art will recognize, given the teachings herein that numerous alternatives and variations exist that do not depart from the invention. It is therefore intended that the invention not be limited by the forgoing description.

What is claimed is:

1. A method for transferring data comprising the steps of:
receiving at a server, a data object for transfer to a wireless device;
identifying delivery information associated with the wireless device; and
automatically formatting the data object for delivery to the wireless device.

2. A method according to claim 1, wherein the delivery information includes an mobile identifier for locating the wireless address.

3. A method according to claim 2, wherein the mobile identifier is a telephone number.

4. A method according to claim 2 wherein the mobile identifier is a network address.

5. A method according to claim 1 wherein the delivery information includes information identifying wireless device capabilities.

6. A method according to claim 5, wherein the step of formatting is based on the wireless device capabilities.

7. A method according to claim 1, wherein the delivery information is provided during a registration process.

8. A method according to claim 1, wherein the step of receiving the data object includes identifying the data object by dragging and dropping a first icon associated with the data object onto a second icon at a desktop computer.

9. A method according to claim 1, wherein the step of formatting includes translating the data object into a desired file format.

10. A method according to claim 1, and further comprising the step of scheduling the data object for delivery to the wireless device at a selected time.

11. A method according to claim 1, and further comprising the step of transmitting the data object to the wireless device.

12. A method according to claim 11, wherein the step of transmitting includes transferring the data object using WAP.

13. A method according to claim 11, wherein the step of transmitting includes transferring the data object using SMS.

14. A method according to claim 11, wherein the step of transmitting includes transferring the data object using MMS.

15. A system for transferring data objects comprising:
a server for receiving a data object for transfer to a wireless device;
storage at the server for maintaining registration information associated with the device; and
a formatter for reformatting the data object based on wireless device capabilities identified in the registration information; and
a scheduler for optionally scheduling delivery of the reformatted data object.
